(19) United States
(12) Patent Application Publication
(10) Pub. No.: US 2009/0141873 A1
(43) Pub. Date: Jun. 4, 2009

(54) SYSTEM FOR IDIOM CONCURRENT TRANSLATION APPLIED TO TELEPHONIC EQUIPMENT, CONVENTIONAL OR MOBILE PHONES, OR ALSO A SERVICE RENDERED BY A TELEPHONIC COMPANY

(76) Inventor: Hector William Gomes, Sao Paulo (BR)

Correspondence Address: STITES & HARBISON PLLC, 1199 NORTH FAIRFAX STREET, SUITE 900, ALEXANDRIA, VA, 22314, US

(21) Appl. No.: 12/089,633

(22) PCT Filed: Jan. 11, 2006
(86) PCT No.: PCT/BR2006/000004

§ 371 Date: Jul. 28, 2008

(30) Foreign Application Priority Data
Oct. 11, 2005 (BR) PI 0504598-3

(51) Int. Cl. H04M 1/64; G06F 17/28; G10L 15/18

(52) U.S. Cl. 379/88.06; 704/4; 704/257; 704/E15.018

(57) ABSTRACT

A system for idiom simultaneous translation applied to telephonic equipment, conventional or mobile phones and service rendered by a telephonic company allowing complete understanding of a conversation between speaker and listener agents, when both speak different idioms, with the main objective is to allow a concurrent translation of the native idiom of the speaker agent to the native idiom of the listener agent, through the introduction of a idiom translation system, composed by a computer readable program supported by a hardware and linked to a voice recognition device, which may be integrated to a generic telephonic equipment, both conventional and mobile, when in a local application, or directly installed in a telephonic central system, as a service to be rendered to its subscribers.

The present claim of patent of invention treats of an original solution in the field of communication, where the application will revolutionize the communication between speaker and listener, specially when they talk different idioms, as for example, the speaker talks in Portuguese and the listener talks in English, and the combination scope between idioms is unlimited.

The inventive system now claimed will allow that, with the activation of a translation system, presented as software, the speaker selects one idiom to concurrent translation from a list of possible idioms.

The concurrent translation is possible due to a high-technology information system, with voice recognition software, widely knew as an alternative to communication systems.

The perspective of dissemination of this new communication technology is very hopeful, since it may be implemented to localized use, it is to say, the system now claimed may be individually installed in telephonic equipment, both conventional and mobile.

Additionally, this system may be traded as a service to be rendered, being added to the wide service package, but as a differential item, since it allows the excellence in oral communication, with special application to businesses or sciences, optimizing time and improving the quality of the communication.

### TECHNIQUE BACKGROUND

With the sole and exclusive intention of providing veracity to the preface of this document, the petitioner makes a brief but consistent explanation about the state-of-art of interpersonal communication, where an expert will be able to recognize its deficient aspects to later identify the invention now claimed as fulfilling the requirements of novelty in accordance with industrial property law.

The human being, during his evolution, has experimented in language his most efficient communication tool, essential condition to organize the society, as we know nowadays.

If we consider an evolution jump to the end of 19^{th} century, when the Industrial Revolution was quickly walking, we can make a parallel with the need of communication among different groups of people.

From the moment the boundaries of the called Old World started to grow to the point all regions of Earth started to interact, an evolution process of communication among different groups, which sociology science invariably labels as “tribes”, started. In that time the communication was not critical, since almost all communication need was restricted to a group of people geographically concentrated and thus having the same linguistic code.

However, from the moment different “tribes” started making part of a macro society, the linguistic differences became an obstacle to the progress of human relations. Bringing our analysis to present days, more specifically to the end of 20^{th} century, it is possible to identify that linguistic differences became more critical, since we started living in a globalized world, where human relations exceed the physical limit imposed by the geography.

Besides the human relations we must add, with a great level of importance, the international and intercontinental commercial relations, where the clear understanding is capital to the success of this kind of relations.

Added to the reported above, there are hundreds of peoples and a hundred of possible idioms (or dialects), most very different, and thus the communication becomes determinant in the relation quality, from a social and commercial point of view.

The classic solution to solve this communication problem passes by the learning of an understandable idiom, being the main commercial factor the main motivation to start this learning process.

However, due to the fantastic speed of the current negotiations, facilitated by the new technologies as mobile telephone and Internet, the called “classic solution” presents a negative and unfeasible aspect to the business world, since it demands a “very long time of learning”.

Except for the professionals that, by different means, have learnt a second idiom—or even a third, fourth or fifth one—most people only speak, if so, its sole native idiom.

If at the end of 80s this condition was not critical, nowadays, with the revolution of communication ways, it is.

Additionally, the easiness experimented by the communication through “digital world”, it is to say “internet”, is now exceeding the limit of writing communication, being that the information technology is experimenting a such condition where the verbalized communication, with spoken negotiation, is mandatory, even if the agents (speaker and listener) are thousands miles distant.

### PROPOSAL

Due to the reported on technique basis the petitioner idealized, in an original way, a software-based system that allows the translation of a native idiom of a speaker to a second idiom, providing a full understanding by the listener of the sent message, without the need of a conventional translation. It is important to highlight that this is a condition of use where the listener agent does not understand, by his/her own means, the native idiom of the speaker agent.

In a similar way, the speaker agent can activate the translation system to receive the verbalized information from the listener agent, duly translated to his/her native idiom.

To allow obtaining this revolutionary tool of universal communication, the petitioner developed a concurrent translator system from a specifically developed software, with voice recognition technology, which can be readily installed in an individualized way, it is to say, directly in a telephonic equipment, both mobile and conventional, or alternatively it can be incorporated to the service package of telephonic companies.

We must also consider that the concurrent translator system, being a software-based application, will be able to be implemented to verbalized communication through IP protocol, a very recent communication technology but that is having an exponential growth in the last years—its concept is based in oral communication through computer.

Besides that, another advantage from a commercial point of view is that the listener agent may not have the translator system in his/her telephonic equipment, since the information is delivered duly translated and with understanding quality.

### FIGURE DESCRIPTION

In order to complement the description and to get a better understanding of the characteristics of the claim of invention, a set of drawings is presented in an exemplified but not limited way, where:

FIG. 1 is a schematic representation of one first functional form, called localized, for application of the translation system now claimed;

FIG. 2 is a perspective view of generic telephonic equipment, in which is applied a preferred form to activate the translation system now claimed;

Detail 1 indicates the switch to activate the translation system now claimed, with idiom selection menu, visualized in a display;

FIG. 3 is a schematic representation of another functional form, called remote application, for application of the translation system now claimed.

### DETAILED DESCRIPTION

The following detailed description must be read and interpreted with the showed drawings and schemes, which are highly illustrative and have no intention to limit the invention scope, this one only limited by the explanations of claiming frame.

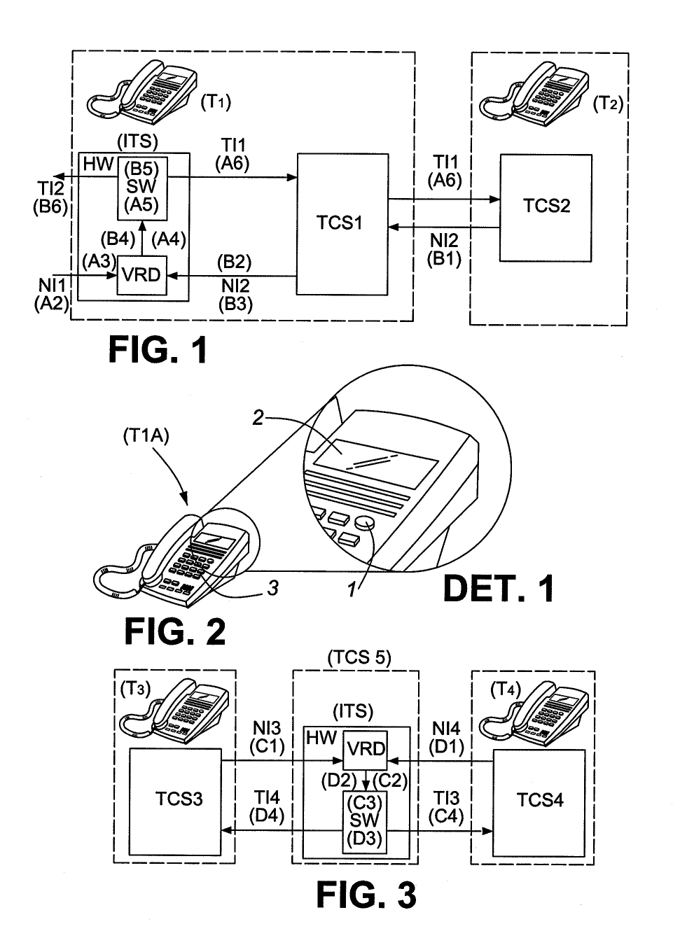

In accordance with the illustrative drawings of the current claim of invention, it is about a “SYSTEM OF IDIOM CONCURRENT TRANSLATION APPLIED TO TELEPHONIC EQUIPMENT, CONVENTIONAL OR MOBILE, OR ALSO A SERVICE RENDERED BY A TELEPHONIC COMPANY” where FIG. 1 is a schematic representation of the localized application form of the idiom translation system (ITS), where the speaker agent uses a telephonic equipment (T1), in a generic way, it is to say, conventional or mobile, or also through information technology based on voice over IP (internet).

The idiom translation system (ITS) is implemented to the telephonic equipment (T1), according to FIG. 2, and receives an activation device (1) and also a small liquid crystal display (2) to show a menu of idiom options (2A) to translation.

The step of introducing the selected idiom (A1) may be made using the keyboard (3), being the preferred way to the telephonic equipment (T1) with simple and practical constructive concept and economically feasible to most people.

Once introduced the selected idiom (A1), the idiom translation system (ITS) is activated, represented by a software (SW) supported by an adequate hardware (HW) that makes possible its correct operation, having a voice recognition device (VRD) as a complement to such software (SW).

The application of the localized form of the idiom translation system (ITS)—FIG. 1—is mainly characterized by the reception of the native idiom (NI) of the speaker agent (A2), starting the idiom recognition (A3), which transits through the voice recognition device (VRD) and it sends the voice signal (A4) duly recognized and treated to the software (SW).

The software (SW) performs the translation of the selected idiom (A5) and the translated idiom (It) is expressed and sent (A6) to the telephonic equipment (T2) of the listener agent.

The reply of the listener agent occurs in a normal way, where a first step of reply emission (B1) he/she emits the verbalized communication in the native idiom (NI) of the listener agent, starting a second step that expresses the reply (B2) where the native idiom (NI) of the listener agent is expressed from the telephonic equipment (T2) and sent to the telephonic equipment (T1) of the speaker agent, starting the step of reply recognition (B3) through a voice recognition device (VRD) to recognize and treat the verbalized communication, starting the step of translation (B4) with immediate reception by the software (SW), which through a program performs the idiom translation, transforming the native idiom (NI), where finally starts the step of reception of the speaker agent (B5), which is made through the dispatch by the listener agent, in the translated idiom (TI), now made by the speaker agent, where he/she understands perfectly the received message in verbalized form.

In a second form of application of the idiom translation system (ITS)—FIG. 3—to be applied by telephonic companies, called remote application, the generic telephonic equipment (T1) and (T2) does not need the idiom translation system (ITS), being that directly installed in the telephonic central system (TCS). The subscriber requires the service through an alphanumeric code using keyboard (3), before starting telephonic call.

Thus the verbalized information in the native idiom (NI) of the speaker agent is expressed, arriving to the telephonic central system (TCS) where, through specific program, the verbalized information is guided to the voice recognition device (VRD) and is duly recognized and treated by the software (SW), which translates to the selected idiom (TI) that is expressed and sent to the telephonic equipment (T2) of the listener agent.

To the treatment procedure of the reply verbalized communication, in the native idiom (NI) of the listener agent, this is expressed from the telephonic equipment (T2) and sent to the telephonic central system (TCS), transiting through the voice recognition device (VRD), where the verbalized communication is recognized, treated and sent to the software (SW) that performs the idiom translation, transforming the native idiom (NI) sent by the listener agent in the translated idiom (TI) of the speaker agent, and is sent to the telephonic equipment (T1) of the speaker agent.

From all that has been described and illustrated, the invention now claimed of idiom translation completely complies with the norms that regulate the Invention Patent in the light of the Industrial Property Law, since fulfills an important lack in the information technology and therefore deserving respective privilege.

1-6. (canceled)

7. A system for local idiom simultaneous translation applied to telephonic equipments, conventional or mobile phones and service rendered by a telephonic company, enabling a speaker agent and a listener agent have complete understanding during a conversation through a translation from a native idiom of the speaker agent into a selected translated idiom of the listener agent, comprising:
(1) an idiom translation system installed in a first telephonic equipment of the speaker agent;
(2) an activation system, including an idiom selection device, installed in the first telephonic equipment, for activating the idiom translation system;
(3) a small liquid crystal display, presenting an idiom menu, installed onto the first telephonic equipment, and
(4) a second telephonic equipment of the listener agent, connected to the first telephonic equipment of the speaker agent.

8. A system for remote idiom simultaneous translation applied to telephonic equipments, conventional or mobile phones and service rendered by a telephonic company enabling a speaker agent and a listener agent have complete understanding during a conversation through a translation from a native idiom of the speaker agent into a selected translated idiom of the listener agent, comprising:
(I) an idiom translation system installed in a remote telephonic central system;
(II) a first telephonic equipment of the speaker agent, connected to the remote telephonic central system;
(III) an activation system, installed in the first telephonic equipment, for selecting the idiom and activating the idiom translation system, and
(IV) a second telephonic equipment of the listener agent, connected to the remote telephonic central system.

9. The system for local idiom simultaneous translation applied to telephonic equipment, conventional or mobile phones and service rendered by a telephonic company, according to claim 7, wherein the idiom translation system is a computer readable program linked to a voice recognition device.

10. A system for remote idiom simultaneous translation applied to telephonic equipment, conventional or mobile phones and service rendered by a telephonic company, according to claim 8, wherein the idiom translation system is a computer readable program linked to a voice recognition device

11. The system for local idiom simultaneous translation applied to telephonic equipment, conventional or mobile phones and service rendered by a telephonic company, according to claim 9, wherein the local simultaneous translation of a verbalized communication by the speaker agent, comprises the following steps:
(a) the speaker agent activating the system;
(b) the speaker agent selecting the translated idiom of the listener agent;
(c) the speaker agent inputting a verbalized communication in the native idiom of the speaker agent on the first telephonic equipment;
(d) the voice recognition device receiving the verbalized communication in the native idiom of the speaker agent;
(e) the voice recognition device recognizing the first native idiom;
(f) the voice recognition device sending a voice signal to the computer readable program;
(g) the computer readable program performing a translation from the native idiom of the speaker agent into the selected translated idiom of the listener agent, and
(h) expressing the selected translated idiom of the listener agent on a second telephonic equipment.

12. The system for local idiom simultaneous translation applied to telephonic equipment, conventional or mobile phones and service rendered by a telephonic company, according to claim 9, wherein the local simultaneous translation of a verbalized communication by the listener agent, comprises the following steps:
(i) the listener agent inputting a verbalized communication in the selected translated idiom of the listener agent on the second telephonic equipment;
(j) the voice recognition device receiving the verbalized communication in the selected translated idiom of the listener agent;
(k) the voice recognition device recognizing the selected translated idiom of the listener agent;
(l) the voice recognition device sending a voice signal to the computer readable program;
(m) the computer readable program performing a translation from the selected translated idiom of the listener agent into the native idiom of the speaker agent, and
(n) expressing the native idiom of the speaker agent on the second telephonic equipment.
